(19) United States
(12) Patent Application Publication
(10) Pub. No.: US 2005/0244582 A1
(43) Pub. Date: Nov. 3, 2005

(54) Method for the production of a grip-promoting and/or slip-resistant coating on a holding section or grip section of a household utensil

(76) Inventor: Georg Weihrauch, Wald-Michelbach (DE)

Correspondence Address: PATENTANWAELTE LICHTI + PARTNER GBR, POSTFACH 41 07 60, D-76207, KARLSRUHE, DE

(21) Appl. No.: 10/525,570

(22) PCT Filed: Aug. 14, 2003
(86) PCT No.: PCT/EP03/09029

§ 371 Date: Feb. 25, 2005

(30) Foreign Application Priority Data
Aug. 27, 2002 (DE) 10240001.6

(51) Int. Cl. B05D 5/00

(52) U.S. Cl. 427/256

(57) ABSTRACT

The invention relates to a method for producting a dotted and/or planar grip-promoting and/or slip-resistant coating on a holding section or grip section of a house-hold utensil, said coating being printed onto the surface of the holding section or grip section by means of a silk screen printing process or a transfer printing process, and especially a tampon printing process. The coating material is disposed in a predetermined configuration that corresponds to a desired printed image on a pattern support (printing block), is then transferred to a transfer element, and is applied to or printed onto the holding section or grip section.

The invention concerns a method for producing a dotted and/or planar grip-promoting and/or slip-resistant coating on a holding or grip section of a household utensil. The term “household utensil” refers to devices, tools or articles which are manually operated and are used, at least at times, in a household, such as e.g. bristle ware, i.e. brushes, toothbrushes, brooms, painting brushes or other painting utensils, tools such as screw drivers, tongs/pliers etc., textile holders or coathangers with slip-resistant coating, toothpicks or interdental cleaning devices. The following description concerns a toothbrush, as an example. Similar problems and effects also occur with the other above-mentioned household utensils which are also included within the scope of the present invention.

A toothbrush usually consists of an elongated, stick-shaped grip section whose front end comprises the brush head which holds the bristle stock. During use of the toothbrush, the user grips its grip section and guides the bristle stock in an oscillating motion over the teeth for cleaning. The grip section may thereby become wet and can slip in the hand of the user. To prevent such slippage, the grip section of a toothbrush has been conventionally provided for some time with a dotted and/or large-surface grip-promoting and/or slip-resistant coating. A corresponding toothbrush is described in WO 01/96088 A1. This toothbrush is produced using the so-called multi- or two-component injection molding method (2-K-method). The brush body of plastic material is initially injected in an injection mold. In a subsequent step, either the injection mold is displaced or the brush body is inserted into another ipjection mold. An elastomeric plastic is subsequently injected onto the brush body. The elastomeric plastic is positively held on the brush body to form a slip-resistant coating on opposite sides of the gripping section.

The use of the 2-K method to form a slip-resistant coating is also known per se for a tool in the form of a screw driver (DE 200 04 373 U1), a hairbrush (WO 00/47081 A1) or a kitchen knife (DE 44 30 738 A1). In this manner, ergonomically advantageous manual grip designs with improved grip can be obtained with increased freedom in design and haptic effect. One disadvantage thereby is, however, that the machines and, in particular, the tools required to perform the 2-K method are very complex and expensive (see e.g. from EP 0 742 090 B1, DE 44 00 649 A1 or EP 0 749 281 B1).

Injection molding tools of this type are produced from high-quality steel and their production is very demanding and expensive. Only production of a very large number of toothbrushes of the mentioned type is economical. Holding and grip sections having similar or identical decorative and functional properties are desired not only for toothbrushes but also for many other products of which, however, considerably fewer piece numbers are required; often as few as merely a few thousand. The production of corresponding toothbrushes using an individually produced injection molding tool is, however, very expensive.

The production of multi-component parts by injection molding has further disadvantages. A decorative second component must form a continuous body, if introduced into the injection molding tool in one single sprue, thereby considerably limiting the design possibilities. In an alternative fashion, a complicated system with a larger number of injection locations can be provided in the tool (EP 0 749 281 B1) thereby increasing the production costs to an even greater extent.

If provision of several injection locations or several demanding hot channel nozzles is avoided for injecting a second or further component, and if the coating is provided on several sides, it must either disadvantageously surround or penetrate through the brush body, thereby consuming substantial amounts of relatively expensive coating material. To distribute the second component, which usually consists of a thermoplastic elastomer, relatively long flow paths are required, in particular, if the elastomer component is to be distributed over a large region of the holding or grip section of the toothbrush. The usually limited flow behavior of soft materials for the second component requires relatively large dimensioning of the flow or feed channels, thereby further increasing material consumption.

It is the underlying purpose of the invention to provide a method for simple and inexpensive coating of a grip-promoting and/or slip-resistant coating onto a household utensil of the above-mentioned type.

This object is achieved in accordance with the invention in that the coating is printed on the surface of the holding or grip section of the household utensil.

The invention is based on the principal idea of printing a relatively thin surface structure on the holding or grip section of a household utensil, e.g. a toothbrush, instead of the conventional relatively thick coating using the 2-K method, to thereby improve the force transmission between the hand of the user and the toothbrush without disturbing the use through excessive flexibility of a thick, soft coating.

The costs involved for printing the coating are only a fraction of those required to produce tools for the 2-K method. The flexibility and economy of the inventive method are further increased in that the preparations required to produce a new printing style can be accomplished within one day, whereas the production of an injection molding tool of the mentioned type requires approximately 6 to 9 months. Due to these advantages in view of time and money, the inventive method also permits adjustment of the material selection and configuration of the coating through tests to achieve optimum effects which are suited for the purpose of use of the respective household utensil. If the household utensil is e.g. a trouser hanger whose bar shall be provided with a slip-resistant coating, it may be configured such that a predetermined drawing force must act on the trousers before they slip off the bar. Printing of the slip-resistant coating having a very small height is moreover also advantageous in that the transition to the holding or grip section is very flat and practically continuous. This is advantageous mainly for coat hangers, to prevent pressure points or marks on soft and sensitive fabrics.

The grip-promoting or slip-resistant coating can be printed through various printing methods. The coating may e.g. be applied using a screen printing method. In one particular application, it has proven to be advantageous to initially dispose a structure, e.g. of dotted configuration of a pasty mass having a viscosity of more than 1000 s of a relatively small thickness, e.g. 0.015 mm to 0.020 mm onto a holding or grip section of a household utensil, and print a further layer, which has grip-promoting or slip-resistant properties and may e.g. be transparent, over this structure in a subsequent step, either in areas or over the full surface thereof.

The grip-promoting and/or slip-resistant coating is preferably printed using a transfer printing method and, in particular, a tampon printing method. A recessed structure is thereby etched into or washed out of a pattern support (printing block) in correspondence with the desired print. The material of the grip-promoting and/or slip-resistant coating is subsequently disposed onto the structured surface of the pattern support and removed again until the coating material is located only in the depressions. The coating material is removed from the structured surface of the pattern support using a transfer element, e.g. a printing tampon, and is disposed onto the holding or grip section of the household utensil to be coated. This method, which is known per se in tampon printing, is now used to produce a grip-promoting and/or slip-resistant coating, in particular, with embossed surface. If e.g. a coating medium having a viscosity of approximately 200 is introduced into a depression in a steel printing block having a depth of approximately 100 μm and a circular shape with a diameter of approximately 5 mm and is subsequently doctored and absorbed with a silicon tampon, and transferred to a holding or grip section, a “print” having an oval head shape and a maximum average height of approximately 75 μm is produced thereon. Practical tests have shown that the depth of the depressions in the printing block can be considerably increased beyond 100 μm, thereby obtaining corresponding thicker and embossed coatings. In an advantageous fashion, the depressions of the pattern support or of the printing block have a depth of at least 0.020 mm, i.e. 20 μm and in particular of at least 0.5 mm, wherein a depression having a depth in the range of 1 mm to 2 mm is preferred.

The depressions in the pattern support or the printing block usually have a substantially planar bottom. The embossing which is desired for the grip-promoting and/or slip-resistant dotted or planar coating and its stronger dimensioning can be improved e.g. through particular shaping of the depressions in the pattern support. At least some of the depressions may have an uneven, e.g. concave or convex bottom instead of the usually flat depression bottom. If the depression bottom is concave, the application thickness in the central region of the dotted or planar coating may be larger than in the edge region of the coating. A further increase in the coating thickness throughout its surface and its embossed structure is possible through increasing the viscosity of the coating material.

The holding or grip section of the household utensil to be provided with the grip-promoting and/or slip-resistant coating, may consist of any inorganic or organic soft or hard materials, wood, plastic material or metal being particularly preferred. The holding or grip section to be coated should thereby have a Shore hardness of more than 100 in the final state.

Printing of the slip-resistant coating using a tampon printing method is particularly suited e.g. for handles of household utensils such as toothbrush handles, broom handles, brush and broom sticks, handles for painting tools and other tools. Coating by tampon printing is particularly suited for roller-shaped articles such as tubes, sticks and corresponding containers. The tampon rotation printing method can also be used in this case. Continuous printing with rolling tampons is preferably used for long articles such as sticks, profiles or also monofilaments, which are known from the production of bristle products and for use as interdental cleaning devices. The use for such applications is facilitated through the possibility of small-surface and embossed application.

The coating material is preferably an initially flowable and, after printing, at least partially or completely hardening plastic material. It has proven to be advantageous for the grip-promoting and/or slip-resistant coating to have a Shore hardness of less than 100 in its final state, i.e. after, at least, partial hardening. The coating material should have a viscosity according to DIN 53210 (with a 4 mm nozzle) in the range between 100 and 500 s in the non-hardened flowable state, wherein, in particular, a viscosity of more than 1000 s is preferred.

The dotted or sectionwise grip-promoting and/or slip-resistant coating should have a minimum thickness of 0.020 mm, i.e. 20 μm and, in particular, at least 0.5 mm after hardening. Excellent grip can be obtained if the grip-promoting and/or slip-resistant coating has a minimum thickness of 1.0 mm after hardening. For large-surface or full-surface coatings, a thickness of at least 0.01 mm is provided.

For a dotted grip-promoting and/or slip-resistant coating, the contact surface between the coating and the holding or grip section should be at least 0.5 mm in each direction, and in particular, at least between 1 mm and 5 mm.

The bulging or embossing of the dotted grip-promoting and/or slip-resistant coating is enhanced through good adhesion on the base, i.e. the holding or grip section. For this reason, the surface of the holding or grip section to be printed is preferably pre-treated before printing to increase adhesion. This may be effected e.g. through application of a bonding agent, corona treatment or coating. The surface to be printed may also be washed and/or flamed.

The specific surface tension (cohesion) of the coating material additionally contributes to collection of the coating material in the central regions of the coating. This effect is additionally promoted through increasing the viscosity of the coating material. The embossed design of the dotted coating is furthermore advantageous in that it produces approximately smooth transitions to the neighboring uncoated surface regions of the holding or grip section, thereby optimizing the haptic effects.

The desired grip-promoting and/or slip-resistant properties of the coating are produced, in particular, with initially flowable and subsequently only partially hardening materials, in particular on the basis of plastic materials. Materials of this type having a viscosity of more than 100 are particularly suited. The coating materials may also be prefoamed, foam during printing, or foam or continue to foam after printing.

In particular, for planar grip-promoting and/or slip-resistant coatings, it may be desired to further increase the coating thickness and, in particular, the embossing in sections. This can be obtained through the inventive printing of the grip-promoting and/or slip-resistant coating in a simple manner in that the coating is disposed in two sequentially superposed layers. The layers may consist of similar or different materials having the same or different properties and having the same or different colors. In particular, the last, i.e. the outer layer should consist of an initially flowable and then only partially hardening material or of a material having a Shore hardness of considerably less than 100.

The subsequently imprinted upper layer may thereby be disposed only on a partial region of the underlying layer. In an alternative fashion, the upper layer completely covers the lower layer thereby providing a protective effect for the lower layer.

Individual layers or all layers may be formed from a transparent or translucent material. This is particularly advantageous if the lower layer is printed to form information, e.g. a letter sequence or a decorative element (e.g. logo), wherein the letter sequence or the logo is protected by the layer disposed above and is still visible to the user. If the coating is formed from a plurality of layers, the layer having the information or the logo should be the penultimate layer on which the above-mentioned protective layer is printed.

The layer which is printed later may be disposed only in partial regions of the layer which was printed before and is disposed beneath. In this manner, several small dotted, grip-promoting and/or slip-resistant elements can be printed onto a planar grip-promoting and/or slip-resistant coating in the form of dots, rings, lines or other configuration.

In a preferred embodiment of the invention, the coating contains additional substances, at least in sections, which also determine the surface structure of the grip-promoting and/or slip-resistant coating or its surface effect. They may e.g. be organic or inorganic abrasive particles and/or abrasive fibers which provide the grip-promoting and/or slip-resistant coating with a rough, structured surface. Alternatively or additionally, the coating or at least one of its layers may be magnetic.

The additional substances may also be protective or hold media provided at least locally in the coating which diffuse during use of the household utensil to the outside of the coating to be discharged and, in particular, be received by the hand of the user or, in case of an interdental cleaner, by the mucous membrane of the user's mouth.

In addition or as an alternative to the above-mentioned additional substances, the coating may, at least in sections, be electrically conducting which can be obtained e.g. through introduction of a carbon black filling at least in some areas.

Organic or inorganic substances of all types can be introduced into the individual layers of a multi-layer coating or also between the individual layers.

The structured coating surface can also be supported by providing elevations on the holding or grip section, on which the slip-resistant coating is disposed, wherein the elevations are at least partially covered by the coating. The elevations may be integral with the holding or grip section or be printed onto the holding or grip section in a preceding step. The holding or grip section may additionally or alternatively have depressions, wherein the coating is disposed at least partially in the depressions. The grip-promoting and/or slip-resistant coating may thereby completely fill the depressions and bulge out therefrom. It is also possible for only part of the volume of the depression to be filled with the coating material.

Further details and features of the invention can be extracted from the following description of embodiments with reference to the drawings.

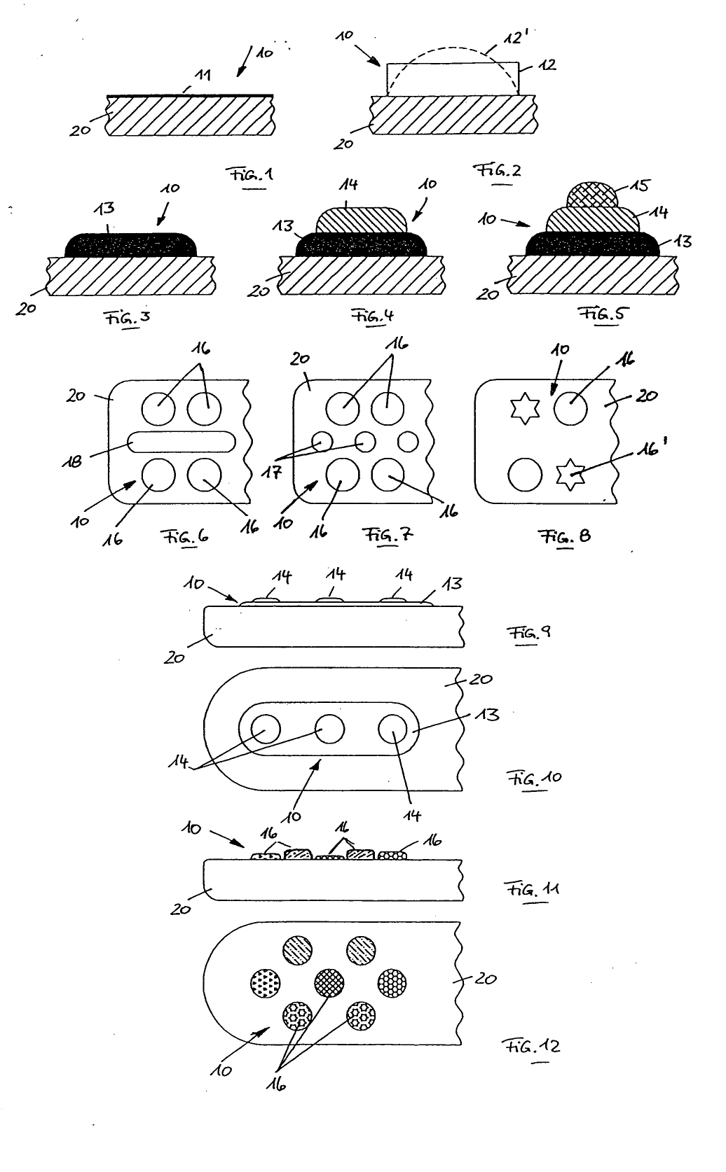

FIG. 1 shows a sectional cross-section through a holding and grip section with printed planar coating;

FIG. 2 shows an embodiment with dotted coating;

FIG. 3 shows a one-layer coating;

FIG. 4 shows a two-layer coating;

FIG. 5 shows a three-layer coating;

FIG. 6 shows a view onto a coating of a first configuration;

FIG. 7 shows a view onto a coating of a second configuration;

FIG. 8 shows a view onto a coating of a third configuration;

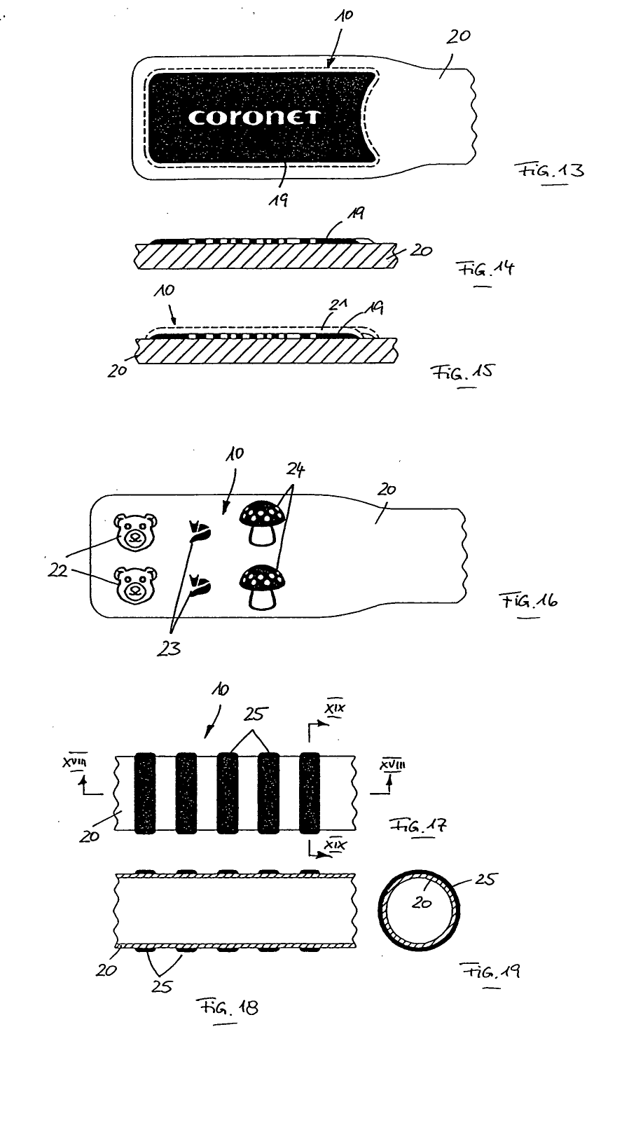

FIG. 9 shows a view of a combined planar, dotted coating;

FIG. 10 shows a view onto the coating in accordance with FIG. 9;

FIG. 11 shows a view of a coating which consists of different coating dots,

FIG. 12 shows a view onto the coating in accordance with FIG. 11;

FIG. 13 shows a view onto a multi-layer coating with information;

FIG. 14 shows a first stage of the design of the coating in accordance with FIG. 13;

FIG. 15 shows a second stage of the design of the coating in accordance with FIG. 13;

FIG. 16 shows a coating with decorative elements;

FIG. 17 shows a view of a tube with a coating in the form of several rings;

FIG. 18 shows the section XVIII-XVIII of FIG. 17;

FIG. 19 shows the section XIX-XIX of FIG. 17;

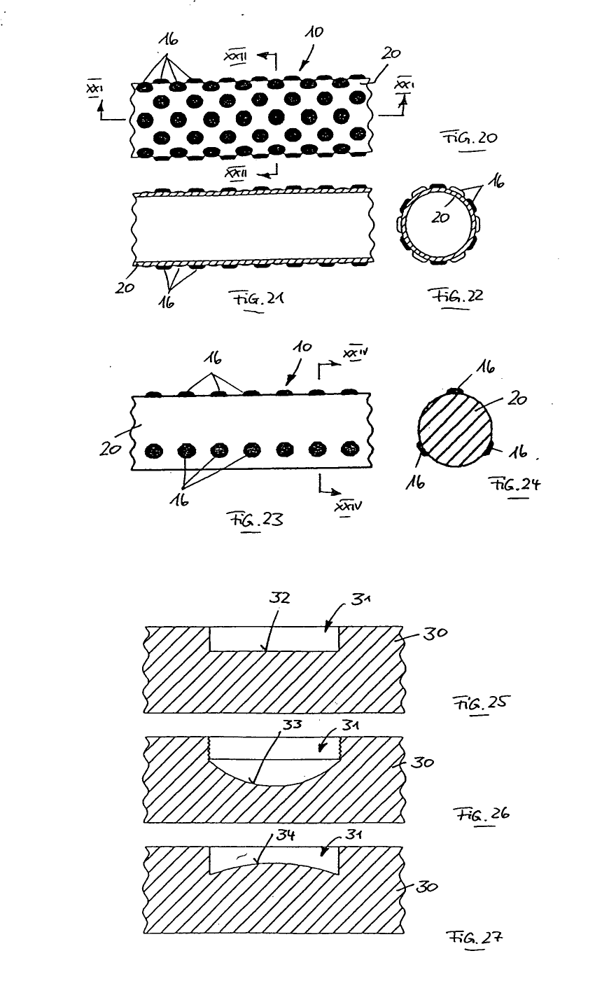

FIG. 20 shows a view of a tube with a coating which consists of a plurality of dots;

FIG. 21 shows the section XXI-XXI of FIG. 20;

FIG. 22 shows the section XXII-XXII of FIG. 20;

FIG. 23 shows a variation of the coating in accordance with FIG. 20;

FIG. 24 shows the section XXIV-XXIV of FIG. 23;

FIG. 25 shows a design of a depression of a pattern support (printing block) of a tampon printing device;

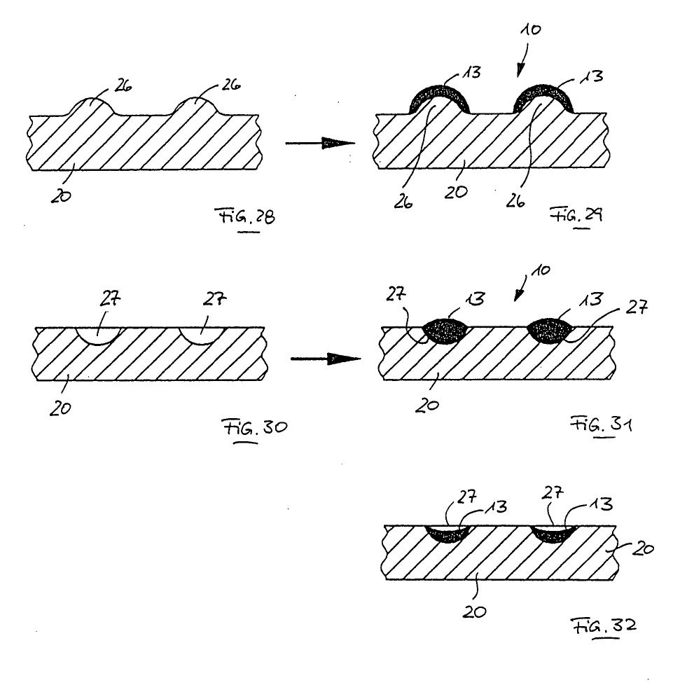

FIG. 26 shows a variation of the depression in accordance with FIG. 25;

FIG. 27 shows a further variation of the depression of FIG. 25;

FIG. 28 shows a holding or grip section provided with elevations before application of the coating;

FIG. 29 shows the holding or grip section of FIG. 28 after application of the coating;

FIG. 30 shows a holding or grip section provided with depressions, before application of the coating;

FIG. 31 shows the holding or grip section in accordance with FIG. 30 after application of the coating; and

FIG. 32 shows a variation of the method in accordance with FIG. 31.

FIG. 1 shows a sectional cross-section of a holding or grip section 20 e.g. of a toothbrush which is provided on its upper side with a grip-promoting and/or slip-resistant coating 10 which is printed in the form of one single layer 11 onto a large surface of the holding or grip section 20.

FIG. 2 shows the coating principle of a dotted coating. A grip-promoting and/or slip-resistant coating material 12 is disposed substantially uniformly onto the holding or grip section 20, which adheres to the holding or grip section 20 and subsequently bulges into an embossed coating dot 12′ which is convex towards the outer side, due to surface tension (cohesion).

FIGS. 3 through 5 show the possibility of disposing the grip-promoting and/or slip-resistant coating 10 in one or more layers. In accordance with FIG. 3, the coating 10 is disposed onto the holding or grip section 20 as one single layer 13. In a subsequent step, a further layer 14 is printed onto the layer 13 (FIG. 4) which is disposed only in a partial region of the lower layer 13. If a three-layer coating is desired, a third layer 15 may additionally be printed onto the second layer 14 (see FIG. 5), wherein the third layer 15 is disposed only in partial regions of the surface of the second layer 14.

FIG. 6 shows a possible configuration of the grip-promoting and/or slip-resistant coating 10 which consists of several coating dots or circles 16 and an intermediate elongated coating element 18 in the embodiment shown. In the embodiment of FIG. 7, the elongated coating element 18 is replaced by several small coating dots 17.

FIG. 8 shows the possibility of designing the coating dots either in a circular (coating dot 16) or also star-shaped (coating dot 16′) manner.

FIGS. 9 and 10 show an embodiment, with which a grip-promoting and/or slip-resistant coating 10 is disposed onto the holding or grip section 20, wherein initially an elongated planar coating layer 13 is printed, on the surface of which several coating dots 14 are printed. The coating dots 14 may thereby consist of the same or a different material than the layer 13.

In the design of FIGS. 11 and 12, the holding or grip section 20 has a plurality of coating dots 16 which consist of different materials (as indicated in the illustration) and also have different thicknesses.

FIGS. 13 through 15 show an embodiment, wherein the coating 10 simultaneously serves as information carrier. FIG. 14 shows that a planar grip-promoting and/or slip-resistant coating 19 is initially disposed onto the holding or grip section 20, which is recessed in its central region corresponding to the desired information (in the present case, the word “Coronet”). In a subsequent step, a further layer 21 is printed onto the layer 19 (FIG. 15), which is transparent at least in sections and completely covers the lower layer 19. At least the upper layer 21 consists of a grip-promoting and/or slip-resistant soft material.

The grip-promoting and/or slip-resistant coating 10 may also comprise decorative motifs in the form of e.g. the head of an animal 22, a fox 23 or a mushroom 24 (FIG. 16), wherein these decorative elements may be designed in one layer or several layers.

FIGS. 17 through 19 show a grip-promoting and/or slip-resistant coating 10 on a holding or grip section 20 in the form of a tube or an extruded profile. The coating thereby comprises several rings 25 disposed one behind the other with intermediate separations in the longitudinal direction of the profile, the rings 25 completely surrounding the profile 20 transverse to its longitudinal extension.

The embodiment in accordance with FIGS. 20 through 22 shows an alternative design of the coating 10 on the holding or grip section 20 which is in the form of a tube or a profile 20. The coating 10 thereby comprises a plurality of coating dots 16 which are disposed in rows extending in the longitudinal direction of the profile, wherein neighboring rows are offset in the longitudinal direction by approximately one dot diameter, such that the profile 20 is provided on its outer side with a uniform screen of coating dots 16 which are offset relative to each other.

FIGS. 23 and 24 show a modification of the above-mentioned embodiment, wherein the coating dots 16 are disposed in only three rows extending in the longitudinal direction of the profile 20, wherein the rows are approximately uniformly distributed about the periphery of the profile 20 i.e. at a mutual separation in the peripheral direction of approximately 120 degrees (FIG. 24).

In the described tampon printing method, the coating material is introduced into at least one depression 31 formed in a pattern support (printing block) 30, which is shown in sections in FIG. 25, and is removed therefrom using a tampon transfer element. The depression 31 has a substantially flat bottom 32, such that the coating material received by the tampon has a uniform thickness in all regions (FIG. 25).

FIG. 26 shows a modification of the embodiment of the depression 31 with concave bottom 33, i.e. it is deeper in the central region of the depression 31 than in the edge regions of the depression 31. This design of the depression causes the coating material removed from the depression 31 using the tampon to have a larger thickness in the central region after application onto the surface to be printed.

FIG. 27 shows an alternative design of the depression 31 with convex bottom 34 such that the depression has a larger depth in its edge regions than in its central region. Corresponding design of the depression 31 is particularly reasonable if the printed coating should have an approximately uniform thickness in the hardened state taking into consideration the surface tension (FIG. 2), since the surface tension pulls part of the edge material into the center thereby compensating for the uneven material distribution caused by the convex bottom 34 of the depression 31.

To form a grip-promoting and/or slip-resistant coating 10 on the holding or grip section 20, which projects by a relatively large degree beyond the holding or grip section 20, the holding or grip section 20 may have, in particular, cup-shaped elevations 26 on its surface to be printed, which are printed or coated with the grip-promoting and/or slip-resistant coating 10 (FIG. 28 and 29). The coating dots 13 have a relatively small thickness of grip-promoting and/or slip-resistant material but clearly project past the holding or grip section 20 due to the elevations 26 beneath.

The holding or grip section 20 to be printed may alternatively comprise depressions 27 which are completely or at least approximately filled during printing of the grip-promoting and/or slip-resistant coating. FIG. 31 shows an embodiment, wherein the coating dots 13 of the grip-promoting and/or slip-resistant coating 10 completely fill the depression 27 and bulge out therefrom on the upper side.

In an alternative embodiment, the coating dots 13 may only partially fill the depressions 27 (FIG. 32) such that the coating 10 does not project past the surface of the holding or grip section 20.

1-27. (canceled)

28. A method for producing a dotted, a planar grip-promoting, and a slip-resistant coating on a holding or grip section of a household utensil, the coating being printed onto a surface of the holding or grip section using a transfer printing method, the method comprising the steps of:
a) disposing a coating material on a pattern support or printing block in a predetermined configuration corresponding to a desired printing image;
b) receiving the coating material with a transfer element; and
c) disposing the coating material onto the holding or grip section using the transfer element.

29. The method of claim 28, wherein a tampon printing method is used.

30. The method of claim 28, wherein said pattern support has depressions corresponding to a printing image, wherein the coating material is disposed in the depressions and is removed therefrom at least partially using the transfer element.

31. The method of claim 30, wherein at least one of the depressions has a substantially flat bottom.

32. The method of claim 30, wherein at least one of the depressions has an uneven bottom.

33. The method of claim 32, wherein at least one of the depressions has a concave bottom.

34. The method of claim 32, wherein at least one of the depressions has a convex bottom.

35. The method of claim 30, wherein the depressions have a depth of at least 0.020 mm or of at least 0.5 mm.

36. The method of claim 35, wherein the depressions have a depth in a range of between 1 mm to 2 mm.

37. The method of claim 28, wherein the coating material is an initially flowable and, after printing, at least partially hardened plastic material.

38. The method of claim 37, wherein the coating material is a plastic material which completely hardens after printing.

39. The method of claim 28, wherein the coating has a thickness of at least 0.020 mm or of at least 0.5 mm.

40. The method of claim 39, wherein the coating has a thickness of at least 0.5 mm.

41. The method of claim 28, wherein the surface of the holding and grip section to be coated is pre-treated before printing to increase adhesion.

42. The method of claim 41, wherein the surface of the holding or grip section to be printed is washed, flamed, or subjected to corona treatment.

43. The method of claim 41, wherein a bonding agent is disposed onto the surface of the holding or grip section to be printed.

44. The method of claim 28, wherein the coating comprises at least two layers which are disposed sequentially, one on top of the other.

45. The method of claim 44, wherein the layers comprise different materials.

46. The method of claim 28, wherein the coating contains, at least in sections, additional substances which influence a surface structure or surface effect.

47. The method of claim 46, wherein the additional substances are organic or inorganic abrasive particles or abrasive fibers.

48. The method of claim 46, wherein the additional substances provide the coating with a magnetic effect.

49. The method of claim 46, wherein the additional substances are protecting and maintaining media which diffuse to an outer side of the coating and can be discharged at that location.

50. The method of claim 28, wherein at least sections of the coating are electrically conducting.

51. The method of claim 50, wherein the coating contains a carbon black filling.

52. The method of claim 28, wherein the holding or grip section comprises elevations and the coating at least partially covers the elevations.

53. The method of claim 52, wherein the elevations are printed onto the holding or grip section prior to step c).

54. The method of claim 28, wherein the holding or grip section has depressions and the coating is disposed at least partially in the depressions.
